(19) United States
(12) Patent Application Publication
(10) Pub. No.: US 2013/0188803 A1
(43) Pub. Date: Jul. 25, 2013

(54) EARPIECE

(71) Applicant: QUALCOMM Incorporated, San Diego, CA (US)

(72) Inventors: Gad SHAANAN, La Jolla, CA (US); Marc D. GOLDMAN, San Diego, CA (US); Kevin Wayne BARTIG, San Diego, CA (US); Inhoe KIM, San Diego, CA (US)

(73) Assignee: QUALCOMM INCORPORATED, San Diego, CA (US)

(21) Appl. No.: 13/686,898

(22) Filed: Nov. 27, 2012

Related U.S. Application Data
(60) Provisional application No. 61/588,827, filed on Jan. 20, 2012.
(60) Provisional application No. 61/652,224, filed on May 27, 2012.

(51) Int. Cl. H04R 5/033

(52) U.S. Cl. CPC H04R 5/033
USPC 381/74

(57) ABSTRACT

An earpiece that enables efficient interaction between a user and a user's various wireless devices. An earpiece may include a first and second speaker, processor, memory battery, and various antennas. The first and second speakers may be configured and positioned on the earpiece so that when the earpiece is worn by a user the speakers do not block or enter an ear canal of the user.

### RELATED APPLICATIONS

This application claims the benefit of priority to U.S. Provisional Patent Application Ser. No. 61/588,827 entitled “Personal Hub” filed Jan. 20, 2012 and U.S. Provisional Patent Application Ser. No. 61/652,224 entitled “Personal Hub” filed May 27, 2012, the entire contents of both of which are hereby incorporated by reference.

### BACKGROUND

There is an ever growing population of wireless devices, many offering significant capabilities of interest to wireless device users. As examples, various wireless devices are enabled to send and receive communications, such as e-mails, text messages, and phone calls, other wireless devices may stream media, such as music and videos, and still other wireless devices may serve as personal assistants to their user's, such as by providing calendar applications, personal organizer applications, and turn-by-turn navigation applications. While the capabilities of wireless devices are significant, often a user must utilize multiple wireless devices to realize all the capabilities the user may desire. Often a user may physically interact with his or her wireless devices via one or more earpieces.

### SUMMARY

The various embodiments provide an earpiece that enables efficient interaction between a user and a user's various wireless devices. In an embodiment, an earpiece may include a first and second speaker, processor, memory battery, and various antennas.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram illustrating a side view of an earpiece according to the various embodiments.

FIG. 2 is another side view of an earpiece according to the various embodiments.

FIG. 3 is a component block diagram illustrating a speaker housing of an earpiece according to the various embodiments.

FIG. 4 is a component block diagram illustrating a battery and antenna arrangement of an earpiece according to the various embodiments.

FIG. 5 is a perspective view of an embodiment earpiece showing a first side.

FIG. 6 is a perspective view of an embodiment earpiece showing a second side.

FIG. 7 is a detail perspective view of a speaker housing of an earpiece according another embodiment.

FIG. 8 is a component block diagram illustrating a side view of an earpiece according to another embodiment.

FIG. 9 is another side view of the earpiece according to the embodiment illustrated in FIG. 8.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “wireless device,” refers to any one or all of cellular telephones, tablet computers, personal data assistants (PDAs), palm-top computers, notebook computers, laptop computers, personal computers, wireless electronic mail receivers and cellular telephone receivers (e.g., the Blackberry® and Treo® devices), multimedia Internet enabled cellular telephones (e.g., Blackberry Storm®), multimedia enabled smart phones (e.g., Android® and Apple iPhone®), and similar electronic devices that include a programmable processor, memory, a communication transceiver, and a display.

The various embodiments provide an earpiece that enables efficient interaction between a user and a user's various wireless devices. In an embodiment, the earpiece may include first and second speakers, a processor, memory, a battery, and various antennas. The first and second speaker may be configured so that the speaker housing does not block or enter the ear canal of a user. In this manner, the first and second speaker may float outside the ear canal of a user enabling the user to hear ambient sounds even when wearing/using the earpiece. The first speaker may be a high frequency speaker and the second speaker may be a low frequency speaker. In an embodiment, the second speaker may be a directional speaker configured to direct sound into a user's ear canal without blocking or entering the user's ear canal.

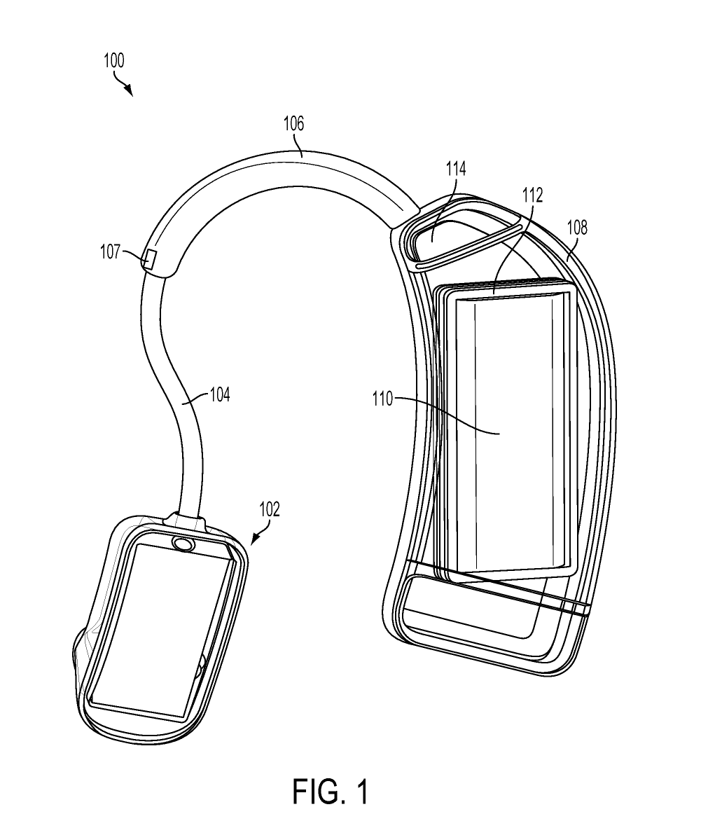

FIG. 1 illustrates a side view of an embodiment earpiece 100. The earpiece may comprise a speaker housing 102 and a main housing 108. In an embodiment the main housing 108 may include a rigid support arm 106 extending from the main housing 108. The main housing 108 may be coupled to the speaker housing 102 by a bendable wire 104 extending from the rigid support arm 106. The bendable wire 104 may provide a mechanism by which the user can adjust the normal position of the speaker housing 102 so that it fits his/her ear in a comfortable manner The earpiece 100 may include a microphone 107. The microphone 107 may be located in various locations on the earpiece 100. In an embodiment, the microphone 107 may be coupled to the rigid support arm 106 at the end of the rigid support arm 106 from which the bendable wire 104 extends. In an embodiment, the microphone 107 may be a directional microphone enabling the amplification of sounds received from the direction the microphone 107 may be pointing for the user of the earpiece 100. The main housing 108 may enclose a battery 110 and first antenna 112 coupled to the battery 110 via a diode or rectifier circuit. In an embodiment, the first antenna 112 may be a coil antenna wrapped around the battery 110 and the first antenna 112 and diode or rectifier circuit may be configured to enable inductive charging of the battery 110 when the earpiece 100 is placed in proximity of a charging station. The battery 110 may be coupled to a circuit board 114. Although the first antenna 112 is illustrated as a coil antenna wrapped around the battery 110, the first antenna 112 may have other shapes and form factors, for example, a coil formed into a planar shape or a printed structure, such as a printed coil formed from a flexible film.

In one embodiment, the earpiece 100 may be configured to hang from, rest upon, and/or otherwise be supported by a user's ear when the earpiece 100 is worn by the user. For example, when the user wears the earpiece 100, the bendable wire 104, the rigid support arm 106, and/or other portions of the earpiece 100 may contact at least a portion of the user's ear, which may allow the earpiece 100 to hang from, rest upon, and/or otherwise be supported by the user's ear.

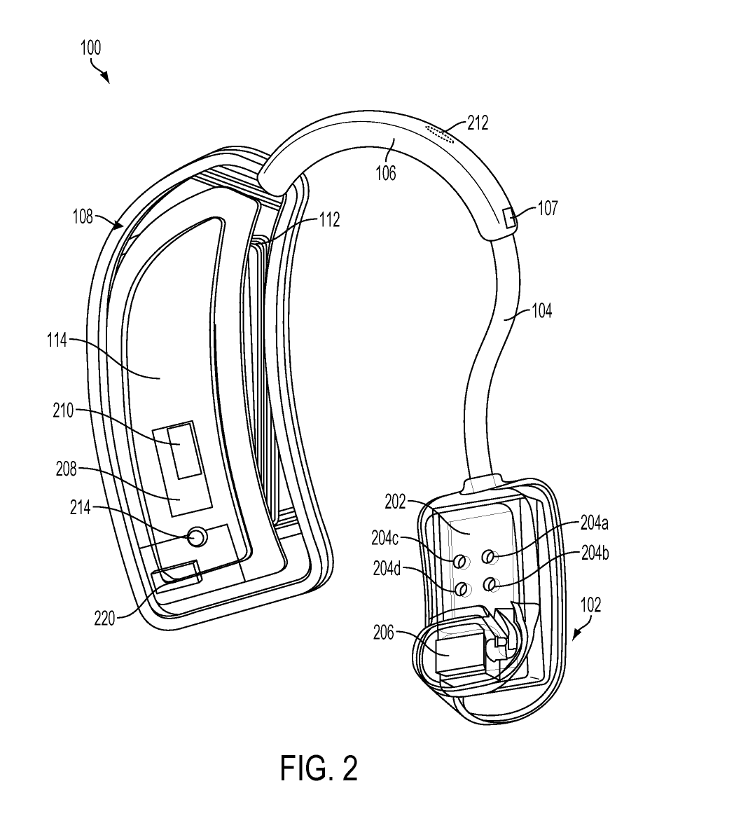

FIG. 2 illustrates a side view of an embodiment earpiece 100 opposite the side view illustrated in FIG. 1. In an embodiment, the speaker housing 102 may enclose a first speaker 202 and a second speaker 206. In an embodiment the first speaker 202 may be a high frequency speaker and the second speaker 206 may be a low frequency speaker. In an embodiment, the first speaker 202 and the second speaker 206 may have their own speaker drivers. The speaker housing 102 may be configured to create speaker outlet holes 204a, 204b, 204c, and 204d. In an embodiment, a processor 208 may be coupled to a memory 210. The processor 208 may be coupled to the battery 110 and to a radio frequency (RF) transceiver 220, which is coupled to a second antenna 212. In an embodiment the RF transceiver 220 may be a Bluetooth® transceiver and the second antenna 212 may be configured to transmit and receive RF signals within the Bluetooth® frequency bands. In embodiments in which the RF transceiver 220 is an RF transceiver, the processor 208 of the earpiece 100 may transmit and/or receive RF signals via the second antenna 212 to/from other wireless devices. In an embodiment in which two or more earpieces 100 may be used together as part of a system, such as part of a personal hub system, the earpieces 100 may be in communication with each other via their respective RF transceivers 220 and second antennas 212, and may coordinate their respective microphone 107 inputs to correlate and balance their audio outputs to the user. The processor 208 may also be coupled to a reset button 214.

The processor 208, memory 210, and second antenna 212 may be coupled to the circuit board 114. The processor 208, RF receiver, memory 210, battery 110, diode or rectifier circuit, and first antenna 112, may be enclosed by the main housing 108. In an embodiment, the second antenna 212 may be included in the rigid support arm (as shown) or within the main housing 108. In an embodiment, the first speaker 202 and the second speaker 206 may be coupled to the processor 208 and the battery 110 by wires and a diode or rectifier circuit. In an embodiment, the wires may run through the rigid support arm 106 and the bendable wire 104. In an embodiment, the signals, such as audio signals, sent and/or received via the second antenna 212 may be converted by the processor 208 into an audio output from the first speaker 202 and the second speaker 206. In an embodiment, the bendable wire 104 may be molded around the wires coupling the first speaker 202 and the second speaker 206 to the processor 208 and the battery 110. In an embodiment, the microphone 107 may be coupled to the processor 208 and the battery 110 by wires running through the rigid support arm 106. In an embodiment, inputs received from the microphone 107 may be used by the processor 208 to improve sound quality of outputs of the first speaker 202 and the second speaker 206. In an embodiment, inputs received from the microphone 107 may be used by the processor 208 to improve hearing assistance to a user of the earpiece 100.

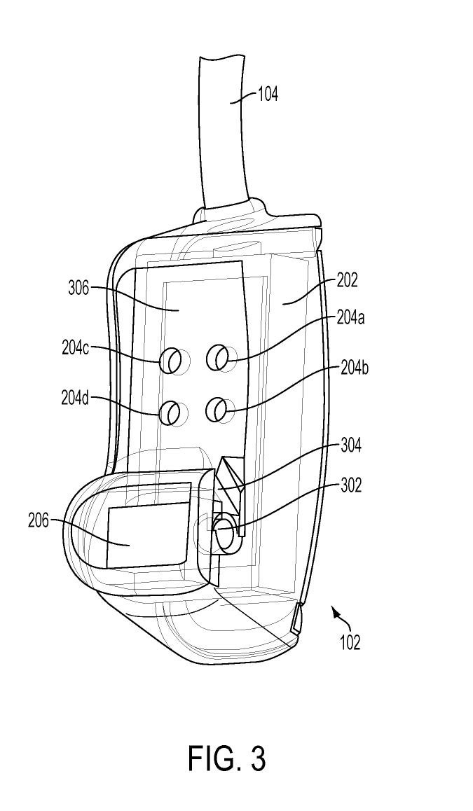

FIG. 3 illustrates an embodiment speaker housing 102 of an earpiece 100. In an embodiment, the second speaker 206 may be a high frequency speaker. The diaphragm 302 of the second speaker 206 may face in a different direction than the diaphragm 306 of the first speaker 202. In an embodiment, the diaphragm 302 of the second speaker 206 may be perpendicular to the diaphragm 306 of the first speaker 202. In another embodiment, the diaphragm 302 of the second speaker 206 may be angled away from the diaphragm 306 of the first speaker 202. In another embodiment, the diaphragm 302 of the second speaker 206 may be angled toward the diaphragm 306 of the first speaker 202. In an embodiment, the second speaker 206 may include a filter mesh covering the diaphragm 302 of the second speaker 206 and the second speaker 206 may be angled away from the diaphragm 306 of the first speaker 202, which may help balance sound between the first speaker 202 and the second speaker 206. A sound path 304 may channel sound from the diaphragm 302 of the second speaker 206 toward the speaker outlet holes 204a, 204b, 204c, and 204d of the first speaker 202. The sound path 304 length, dimensions, and orientation may be selected to accentuate the desired high frequency of the earpiece 100. In an embodiment, the configuration of the first speaker 202 and the second speaker 206 in the speaker housing 102 may be such that in operation the speaker housing 102 does not block or enter the ear canal of a user of the earpiece 100. In this manner, the first speaker 202 and the second speaker 206 may float outside the ear canal of a user enabling the user to hear ambient sounds even when wearing/using the earpiece 100. In an embodiment, no portion of the earpiece 100 may block or enter the user's ear canal while the earpiece 100 is in use by the user.

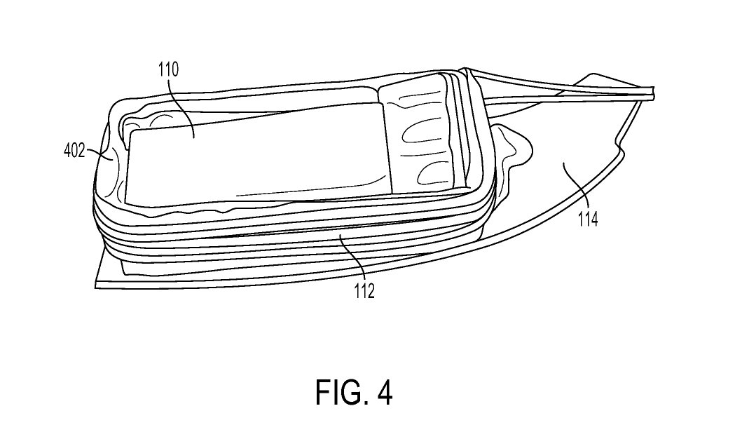

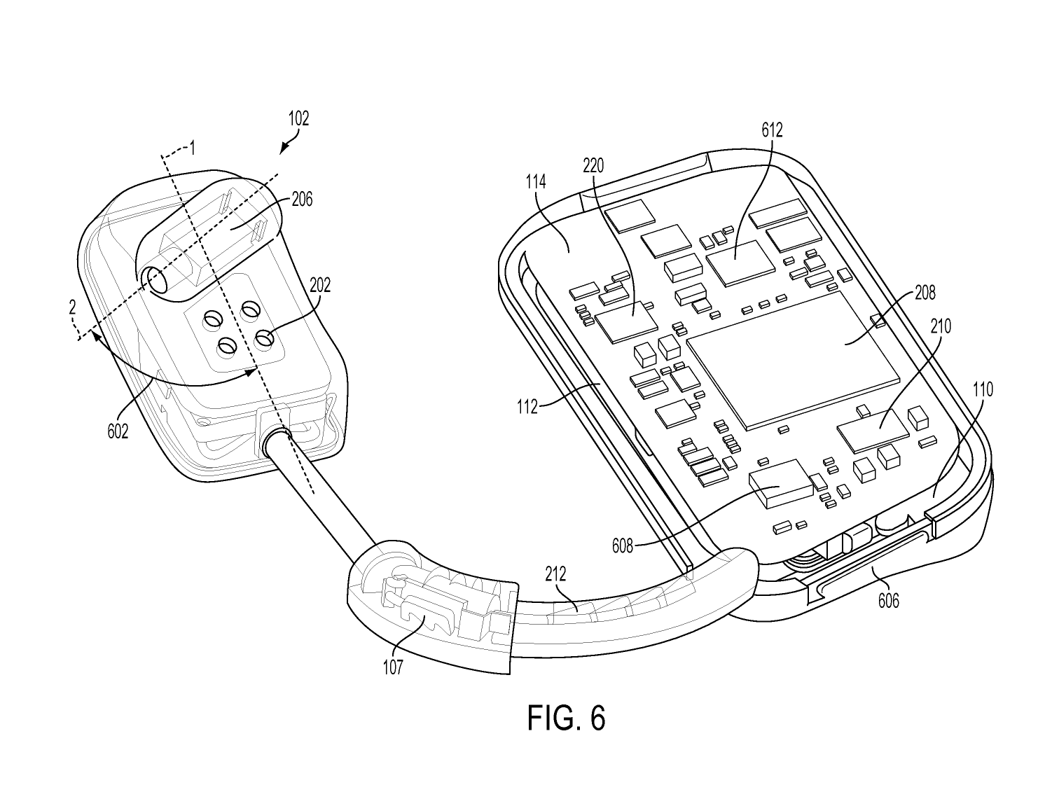

FIG. 4 illustrates an embodiment arrangement of the battery 110 and the first antenna 112 on the circuit board 114. In an embodiment the first antenna 112 may be a coil antenna wrapped around the battery 110. In a further embodiment, magnetic shielding material 402 may be placed around the battery 110 between the first antenna 112 and the battery 110 to shield the battery 110 from the first antenna 112. In an embodiment, the magnetic shielding material may be coupled to the circuit board 114. As discussed further below, in an embodiment, the battery 110 may be encapsulated in magnetic shielding material to stabilize the battery 110 and give the earpiece 100 a known inductive loss during inductive charging. In an embodiment, the earpiece 100 components, such as a the processor 208, memory 210, battery 110, crossover filter (discussed below with reference to FIG. 6), etc, on the circuit board 114 within the main housing 108 may be covered in a blanket of magnetic shielding material to stabilize the components on the circuit board 114 and give the earpiece 100 a known inductive loss during inductive charging.

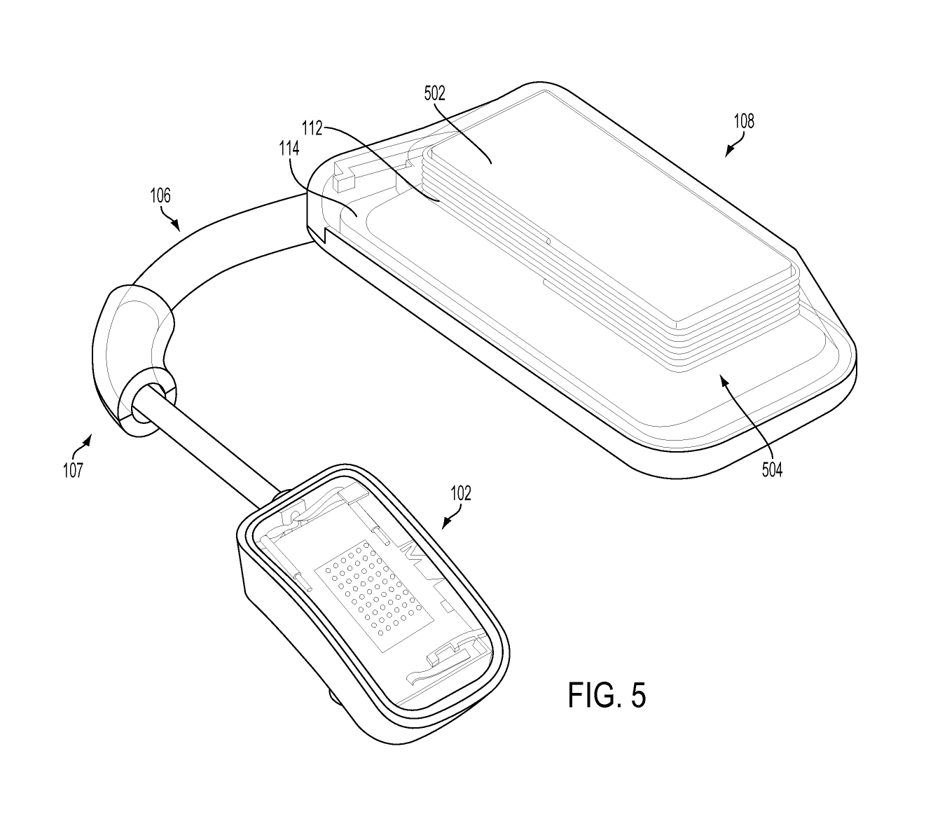

FIGS. 5-7 illustrate alternate configurations of various features of the earpiece 100 described above with reference to FIGS. 1-4. The following descriptions of FIGS. 5-7 focus on features that may be different from those features described above with reference to FIGS. 1-4.

FIG. 5 is a side view of an embodiment earpiece 100 similar to that illustrated in FIG. 1. In the embodiment illustrated in FIG. 5, the battery 110 may be fully encapsulated by magnetic shielding material by placing a cover of magnetic shielding material 502 over the battery 110. Additionally, FIG. 5 illustrates that a blanket of magnetic shielding material 504 may separate the battery 110 and first antenna 112 from the circuit board 114.

FIG. 6 is a side view of an embodiment earpiece 100 opposite the side view illustrated in FIG. 5. FIG. 6 illustrates that in an embodiment, the second antenna 212 may be coupled to an RF receiver and/or RF transceiver 220 coupled to the processor 208. In an embodiment, the second antenna 212 may be a Bluetooth® antenna and the RF transceiver 220 may be a Bluetooth® transceiver. The second antenna 212 and RF transceiver 220 may enable the earpiece 100 to send and/or receive signals from other wireless devices, such as other earpieces and/or smart phones. In an embodiment, additional transceivers may be included in the earpiece 100 or the RF transceiver 220 may be configured to communicate via multiple wireless communication protocols (e.g., a multi-frequency, multi-protocol transceiver).

Additionally, the earpiece 100 may include one or more buttons, such as button 606, coupled to the processor 208. In an embodiment, the processor may be configured with processor-executable instructions to perform operations in response to receiving a signal from a depressed button 606, such as powering on or off, synching, and/or changing the volume of earpiece 100.

In an embodiment, a main housing 108 may be configured such that the microphone 107 may be pointed toward the mouth of a user when the user is wearing the earpiece 100 and the microphone 107 may be configured to pick up the words/sounds uttered by the user and those nearby. In an embodiment, the processor 208 may be configured with processor-executable instructions to transmit the words/sounds received by the microphone 107 via the RF transceiver 220 and second antenna 212. In this manner, words/sounds received by the microphone 107, such as words/sounds uttered by the user, may be sent to other devices, such as a user's smart phone.

FIG. 6 also illustrates that the earpiece may include a crossover filter 608 coupled to the first speaker 202, the second speaker 206, and the processor 208. In an embodiment, the crossover filter 608 may be enclosed by the main housing 108 as illustrated. In an embodiment, the crossover filter 608 may be a first order filter configured to split the audio signals generated by the processor 208 and provide a portion of the audio signals to the first speaker 202 and a portion of the audio signals to the second speaker 206. In an embodiment, the second speaker 206 may be a higher frequency speaker than the first speaker 202, and the second speaker 206 may serve as a directional tweeter while the first speaker 202 may serve as a woofer. In such an embodiment, the crossover filter 608 may direct high frequency signals to the driver of the second speaker 206 and direct low frequency signals to the driver of the first speaker 202. In an alternative embodiment, the processor 208 may be configured with processor-executable instructions to perform operations to serve as a crossover filter for the first speaker 202 and the second speaker 206.

FIG. 6 also illustrates an alternative configuration of the earpiece 100 in which the speaker housing 102 is configured such that the center axis 2 of the second speaker 206 is angled at an acute angle 602 relative to the center axis 1 of the first speaker 202. In this manner, the acute angel 602 between the first speaker 202 and the second speaker 206 may align the diaphragm 302 of the second speaker 206 with the ear canal of a user when the earpiece 100 is worn without the earpiece 100 entering the ear canal of the user. In an embodiment, the alignment of the diaphragm 302 of the second speaker 206 with the ear canal of the user may allow the directional higher frequency second speaker 206 to generate pressure in the ear canal without requiring the earpiece 100 to enter the user's ear canal. In an embodiment, the second speaker 206 may be oriented at an acute angle relative to the first speaker 202 such that the diaphragm 302 of the second speaker 206 is oriented toward the ear canal of the user when the earpiece 100 is worn by the user. In an embodiment, the second speaker 206 may be oriented at an acute angle relative to the first speaker 202 such that a speaker port of the second speaker 206 is oriented toward the ear canal of the user when the earpiece 100 is worn by the user. In an alternative embodiment, the angle 602 may be a perpendicular angle or an obtuse angle, selected to align the diaphragm 302 of the second speaker 206 with the ear canal of a user when the earpiece 100. Since the human ear has less directional sensitivity to lower frequency sounds that will be emitted by the first speaker 202, for example a woofer, the second speaker 206 need not be directed towards the user's ear canal.

FIG. 6 also illustrates the processor 208, memory 210, battery 110, first antenna 112, and second antenna 212 components that are described in more detail above with reference to FIGS. 1 and 2.

In an embodiment, the earpiece may further include a vibrator 612 coupled to the earpiece processor. As an example, the vibrator 612 may be a small electric motor connected by a shaft to an unbalanced disk so that when the motor spins the disk the assembly vibrates. Such vibrations can provide a silent alert or signal to a user that may be felt on a portion of the ear.

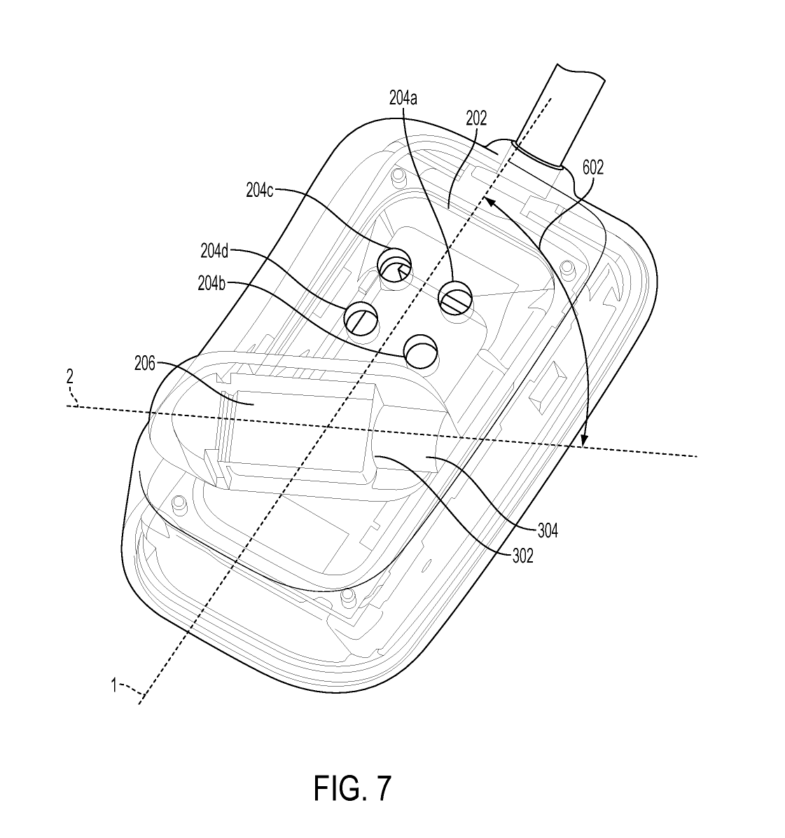

FIG. 7 is an exploded view of an embodiment speaker housing 102 of an earpiece 100 showing the acute angle 602 between the first speaker 202 and the second speaker 206. Additionally, FIG. 7 illustrates that in an embodiment the sound path 304 channeling sound from the diaphragm 302 of the second speaker 206 may run parallel to the center axis 2 of the second speaker 206. In this manner, sound from the diaphragm 302 of the second speaker 206 may be channeled into the ear canal of a user of the earpiece.

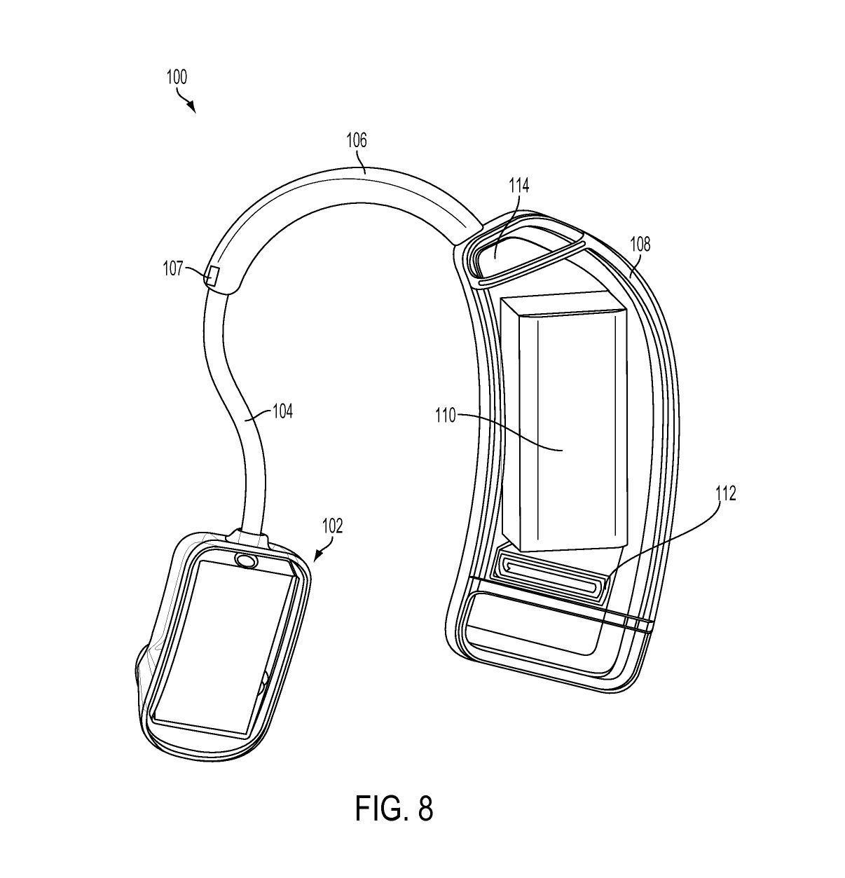

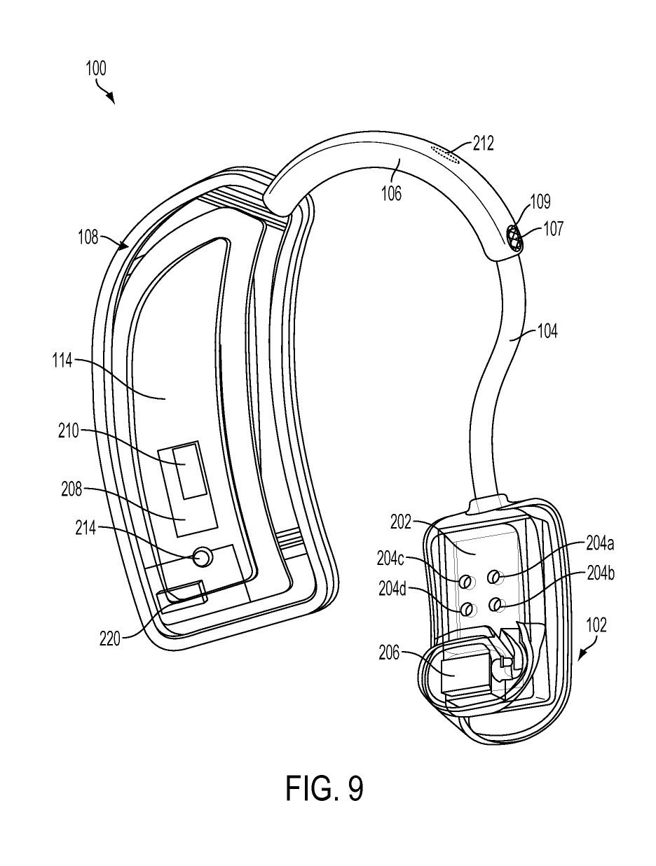

FIGS. 8 and 9 illustrate alternate configurations of various features of the earpiece 100 described above with reference to FIGS. 1-4. The following descriptions of FIGS. 8 and 9 focus on features that may be different from those features described above with reference to FIGS. 1-4.

FIG. 8 is a side view of an embodiment earpiece 100 similar to that illustrated in FIG. 1. In the embodiment illustrated in FIG. 8, rather than being wrapped around the battery 110, the first antenna 112 may be a wireless charging coil antenna, such as a WiPower® antenna, coupled to the bottom of the circuit board 114.

FIG. 9 is a side view of an embodiment earpiece 100 opposite the side view illustrated in FIG. 8. FIG. 9 illustrates that in an embodiment, the microphone 107 may be covered by a windscreen 109 to reduce wind noise.

The processor 208 may be any programmable microprocessor, microcomputer or multiple processor chip or chips that can be configured by software instructions (applications) to perform a variety of functions, including the functions of the various embodiments described above. In some embodiments, multiple processors may be provided, such as one processor dedicated to wireless communication functions and one processor dedicated to running other applications. Typically, software applications may be stored in the internal memory 210 before they are accessed and loaded into the processor 208. The processor 208 may include internal memory sufficient to store the application software instructions. The internal memory may be a volatile or nonvolatile memory, such as flash memory, or a mixture of both. For the purposes of this description, a general reference to memory refers to memory accessible by the processor 208 including internal memory or removable memory plugged into the wearable personal hub and/or earpiece and memory within the processor 208 itself.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. An earpiece, comprising:
a first speaker;
a second speaker;
a speaker housing enclosing the first speaker and the second speaker;
a microphone;
a battery;
a wireless transceiver;
a processor coupled to the first speaker, the second speaker, the battery, the transceiver and the microphone;
a first antenna coupled to the battery; and
a second antenna coupled to the wireless transceiver.

2. The earpiece of claim 1, further comprising:
a main housing enclosing the processor, transceiver, battery, first antenna, second antenna, and microphone; and
a rigid support arm extending from the main housing;
wherein the main housing is coupled to the speaker housing by a bendable wire extending from the rigid support arm, the bendable wire molded around one or more wires coupling the first speaker and the second speaker to the processor, and wherein the microphone is located at an end of the rigid support arm from which the bendable wire extends.

3. The earpiece of claim 2, wherein:
the first antenna is a coil antenna wrapped around the battery and configured to enable inductive charging of the battery; and
the second antenna is configured to transmit and receive radio frequency signals in Bluetooth® frequency bands.

4. The earpiece of claim 2, wherein the speaker housing and the first and second speakers are configured such that when the earpiece is worn by a user the speaker housing does not block or enter an ear canal of the user.

5. The earpiece of claim 2, wherein the first speaker is a low frequency speaker and the second speaker is a high frequency speaker.

6. The earpiece of claim 5, wherein the second speaker is a directional speaker configured to direct sound into an ear canal of a user without blocking or entering the ear canal of the user.

7. The earpiece of claim 6, wherein the second speaker is oriented at an acute angle relative to the first speaker such that a diaphragm of the second speaker is oriented toward the ear canal of the user when the earpiece is worn by the user.

8. The earpiece of claim 6, wherein the second speaker is oriented at an acute angle relative to the first speaker such that a speaker port of the second speaker is oriented toward the ear canal of the user when the earpiece is worn by the user.

9. The earpiece of claim 2, wherein the microphone is a directional microphone.

10. The earpiece of claim 1, wherein:
the first antenna is configured to enable inductive charging of the battery; and
the second antenna is configured to transmit and receive radio frequency signals in Bluetooth® frequency bands.

11. The earpiece of claim 10, wherein the first antenna is a coil antenna wrapped around the battery.

12. The earpiece of claim 10, wherein the first antenna is a coil antenna formed into a planar shape.

13. The earpiece of claim 10, wherein the first antenna is a printed coil antenna formed from a flexible film.

14. The earpiece of claim 1, wherein the speaker housing and the first and second speakers are configured such that when the earpiece is worn by a user the speaker housing does not block or enter an ear canal of the user.

15. The earpiece of claim 14, wherein the earpiece is configured to be supported by a user's ear when the earpiece is worn by the user.

16. The earpiece of claim 14, wherein the earpiece is configured to rest upon a user's ear when the earpiece is worn by the user.

17. The earpiece of claim 14, wherein the earpiece is configured to hang from a user's ear when the earpiece is worn by the user.

18. The earpiece of claim 1, wherein the first speaker is a low frequency speaker and the second speaker is a high frequency speaker.

19. The earpiece of claim 18, wherein the second speaker is a directional speaker configured to direct sound into an ear canal of a user without blocking or entering the ear canal of the user.

20. The earpiece of claim 19, wherein the second speaker is oriented at an acute angle relative to the first speaker such that a diaphragm of the second speaker is oriented toward the ear canal of the user when the earpiece is worn by the user.

21. The earpiece of claim 19, wherein the second speaker is oriented at an acute angle relative to the first speaker such that a speaker port of the second speaker is oriented toward the ear canal of the user when the earpiece is worn by the user.

22. The earpiece of claim 18, wherein the speaker housing and the first and second speakers are configured such that when the earpiece is worn by a user the speaker housing does not block or enter an ear canal of the user.

23. The earpiece of claim 22, wherein the earpiece is configured to be supported by a user's ear when the earpiece is worn by the user.

24. The earpiece of claim 22, wherein the earpiece is configured to rest upon a user's ear when the earpiece is worn by the user.

25. The earpiece of claim 22, wherein the earpiece is configured to hang from a user's ear when the earpiece is worn by the user.

26. The earpiece of claim 1, wherein the microphone is a directional microphone.

27. The earpiece of claim 1, wherein the earpiece is configured to be supported by a user's ear when the earpiece is worn by a user.

28. The earpiece of claim 1, wherein the earpiece is configured to rest upon a user's ear when the earpiece is worn by a user.

29. The earpiece of claim 1, wherein the earpiece is configured to hang from a user's ear when the earpiece is worn by a user.
